(19) United States
(12) Patent Application Publication
(10) Pub. No.: US 2023/0074998 A1
(43) Pub. Date: Mar. 9, 2023

(54) SYSTEM AND METHOD FOR INTEGRATED MULTIMODAL TRAVEL BOOKINGS

(71) Applicant: AERO TRAVEL SOLUTIONS PTY LTD, Melbourne, Victoria (AU)

(72) Inventors: Russell Carstensen, Melbourne (AU); Ahmed Fakhra, Melbourne (AU); Darshana Vithanage, Melbourne (AU); Carl Cruz, Melbourne (AU); Roy Calvo, Melbourne (AU); Wesley Salvador, Melbourne (AU)

(21) Appl. No.: 17/800,123

(22) PCT Filed: Feb. 17, 2021
(86) PCT No.: PCT/IB2021/051305

§ 371 Date: Aug. 16, 2022

(30) Foreign Application Priority Data
Feb. 17, 2020 (AU) 2020900438

(51) Int. Cl. G06Q 10/02

(52) U.S. Cl. CPC G06Q 10/025

(57) ABSTRACT

A system for integrated multimodal travel bookings, the system comprising an application programming interface (API) aggregation gateway configured to provide multiple API connections to multiple travel inventory systems to access, retrieve and aggregate multiformat travel inventory data for a multimodal travel trip by a traveller and a workflow engine configured to execute multiple workflows to merge the aggregated multiformat travel inventory data into multiple travel bookings and send the multiple travel bookings to the multiple travel inventory systems and receive multiple travel confirmations from the multiple travel inventory providers and merge the multiple travel confirmations into an integrated multimodal travel itinerary for the traveller.

### FIELD

The present invention relates generally to a system and method for integrated multimodal travel bookings.

### BACKGROUND

Airlines generally sell tickets either directly to customers (eg, via airline websites or apps) or indirectly (eg, via Global Distribution Systems (GDSs) via third-party distributors, such as travel agencies, Travel Management Companies (TMCs), or Online Travel Agents (OTAs)). GDSs are platforms that enable travel agencies and their clients to access travel data, such as inventories of hotels, airlines, car rentals, and some limited surface travel, such as railway and bus reservations, in real time. GDSs currently act as a central point of aggregation for airline tickets.

Conventional distribution and integration methods for multimodal airline and surface travel using GDSs suffer from several drawbacks. The airline industry, especially Low-Cost Carriers (LCCs), sees GDSs as outdated and expensive, with poor integration capability with surface travel. The International Air Transport Association IATA is currently developing a New Distribution Capability (NDC) designed to address the industry's current distribution limitations, including surface travel sales. However, significant commercial, technical and regulatory barriers remain that prevent a wider adoption of integrated airline-surface travel booking schemes on a wider scale.

For example, the NDC commercial model, and how surface travel providers can access the system, is still currently unclear. In addition, many surface travel providers are not technologically ready for offering sales through the airline booking flows. There is also a lack of data standards across surface travel providers, and no standardised accreditation requirements, which creates technical and bureaucratic challenges when attempting to integrate systems.

In view of this background, there is an unmet need for improved solutions for integrating multimodal travel bookings.

### SUMMARY

According to the present invention, there is provided a system for integrated multimodal travel bookings, the system comprising:
an application programming interface (API) aggregation gateway configured to provide multiple API connections to multiple travel inventory systems to access, retrieve and aggregate multiformat travel inventory data for a multimodal travel trip by a traveller; and
a workflow engine configured to execute multiple workflows to:
   merge the aggregated multiformat travel inventory data into multiple travel bookings;
   send the multiple travel bookings to the multiple travel inventory systems;
   receive multiple travel confirmations from the multiple travel inventory providers; and
   merge the multiple travel confirmations into an integrated multimodal travel itinerary for the traveller.

The multiple workflows may be further configured to process multiple payments for the multiple travel bookings via multiple payment gateways.

The multiple travel inventory systems may comprise Global Distribution Systems (GDSs), Customer Reservation Systems (CRSs), New Distribution Capability (NDC) interfaces, Online Booking Tools (OBT), Online Travel Agencies (OTA), Low-Cost Carrier (LCC) websites, and combinations thereof.

The multiformat travel inventory data may comprise extensible markup language (XML) data, NDC Standard data, JavaScript object notation (JSON) data, Electronic Data Interchange (EDI) data, and combinations thereof.

The multimodal travel trip may comprise airlines, railways, ferries, cruises, buses, hotels, car rentals, tours, events, insurances, and combinations thereof.

The multiple workflows may comprise XML workflows, JSON workflows, EDI workflows, and combinations thereof.

The present invention also provides a computer-implemented method for integrated multimodal travel bookings, the method comprising:
providing multiple API connections to multiple travel inventory systems to access, retrieve and aggregate multiformat travel inventory data for a multimodal travel trip by a traveller;
executing multiple workflows to:
   merge the aggregated multiformat travel inventory data into multiple travel bookings;
   send the multiple travel bookings to the multiple travel inventory systems;
   receive multiple travel confirmations from the multiple travel inventory providers; and
   merge the multiple travel confirmations into an integrated multimodal travel itinerary for the traveller.

The present invention further provides a non-transitory computer-readable storage medium storing a computer program configured, when executed by a processor, to perform a method comprising:
providing multiple API connections to multiple travel inventory systems to access, retrieve and aggregate multiformat travel inventory data for a multimodal travel trip by a traveller;
executing multiple workflows to:
   merge the aggregated multiformat travel inventory data into multiple travel bookings;
   send the multiple travel bookings to the multiple travel inventory systems;
   receive multiple travel confirmations from the multiple travel inventory providers; and
   merge the multiple travel confirmations into an integrated multimodal travel itinerary for the traveller.

### BRIEF DESCRIPTION OF DRAWINGS

Embodiments of the invention will now be described by way of example only with reference to the accompanying drawings, in which:

FIG. 1 is a diagram of a system for integrated multimodal travel bookings according to an embodiment of the present invention;

FIG. 2 is a flow chart of a method for integrated multimodal travel bookings performed by the system;

FIGS. 3A to 3D show a diagram of example multiple workflows of the method for producing an integrated multimodal travel itinerary; and

FIGS. 4A to 4C show an example integrated multimodal travel itinerary produced by the method and system.

### DESCRIPTION OF EMBODIMENTS

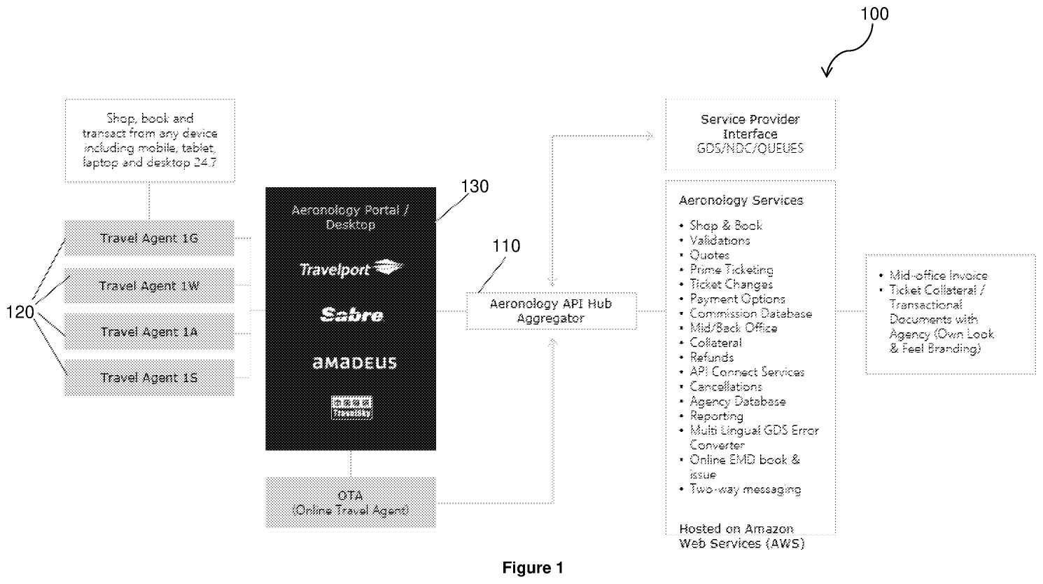

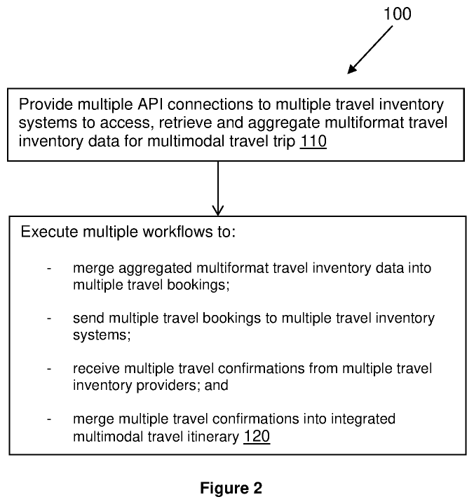

FIG. 1 is a diagram of a system 100 for integrated multimodal travel bookings according to an embodiment of the present invention. The system 100 may comprise an API aggregation gateway 110 configured to provide multiple API connections between travel agent clients 120 and multiple travel inventory systems 130, and a workflow engine (not shown) configured to execute multiple workflows. The API aggregation gateway 110 and workflow engine may be configured to execute a computer program to perform a method 200 shown in FIG. 2.

The method 200 may start at step 210 by providing the travel agent clients 120 with multiple API connections to the multiple travel inventory systems 130 to access, retrieve and aggregate multiformat travel inventory data for a multimodal travel trip by a traveller.

The multiple travel inventory systems 130 may, for example, comprise GDSs, CRSs, NDC interfaces, OBTs, OTAs, LCC websites, and combinations thereof. The multiformat travel inventory data may, for example, comprise XML data, NDC Standard data, JSON data, EDI data, and combinations thereof. The multimodal travel trip may, for example, comprise airlines, railways, ferries, cruises, buses, hotels, car rentals, tours, events, insurances, and combinations thereof.

Next, the method 200 may move to step 220 where the workflow engine executes multiple workflows to process the aggregated multiformat travel inventory data into an integrated multimodal travel itinerary for the traveller. The multiple workflows may, for example, comprise XML workflows, JSON workflows, EDI workflows, and combinations thereof.

The processing performed by the multiple workflows of the workflow engine may, for example, comprise merging the aggregated multiformat travel inventory data into multiple travel bookings, sending the multiple travel bookings to the multiple travel inventory systems, receiving multiple travel confirmations from the multiple travel inventory providers, and merging the multiple travel confirmations into an integrated multimodal travel itinerary for the traveller. Optionally, the multiple workflows may, for example, be further configured to process multiple payments for the multiple travel bookings via multiple payment gateways.

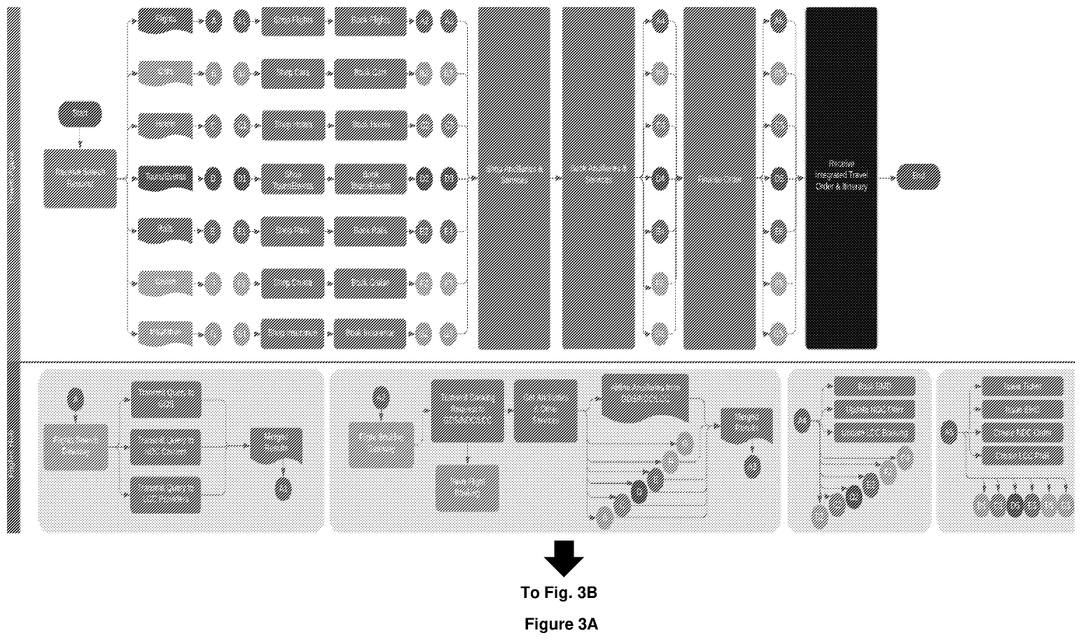

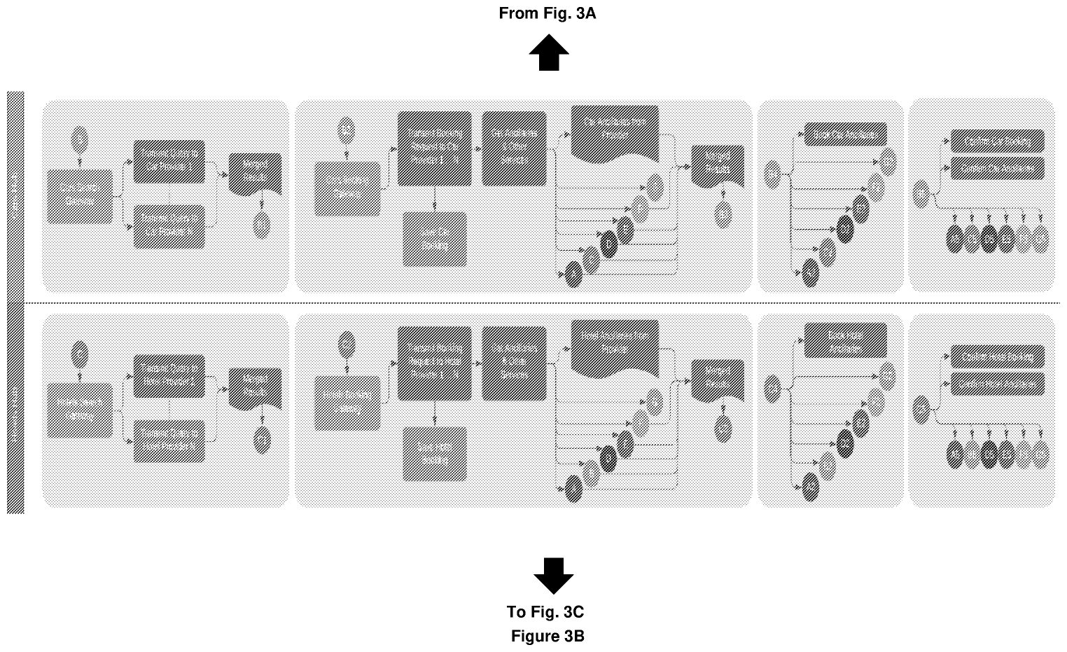

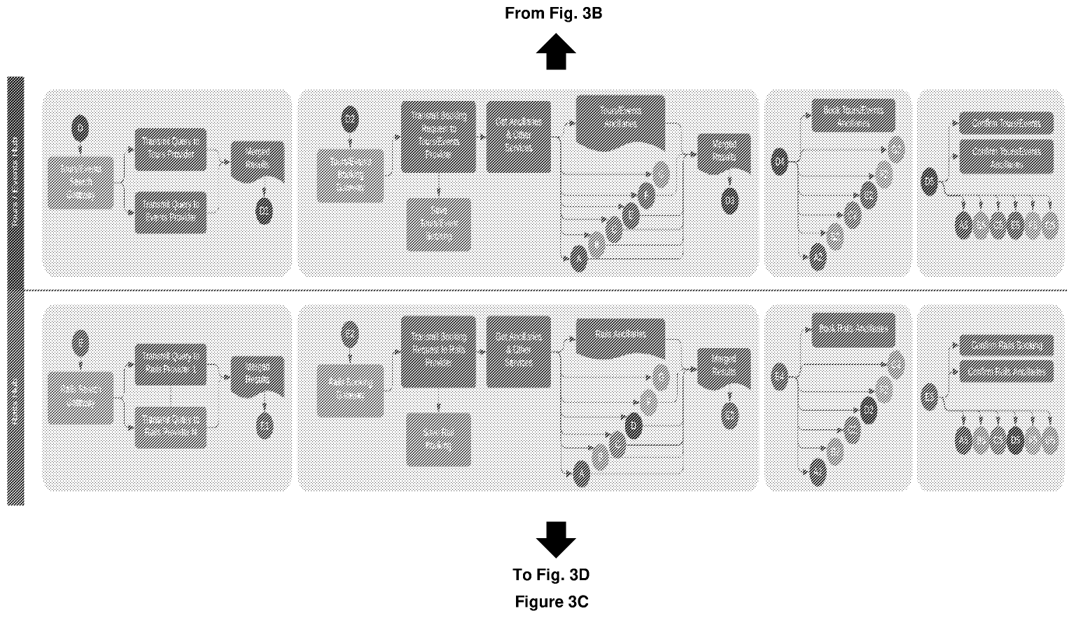

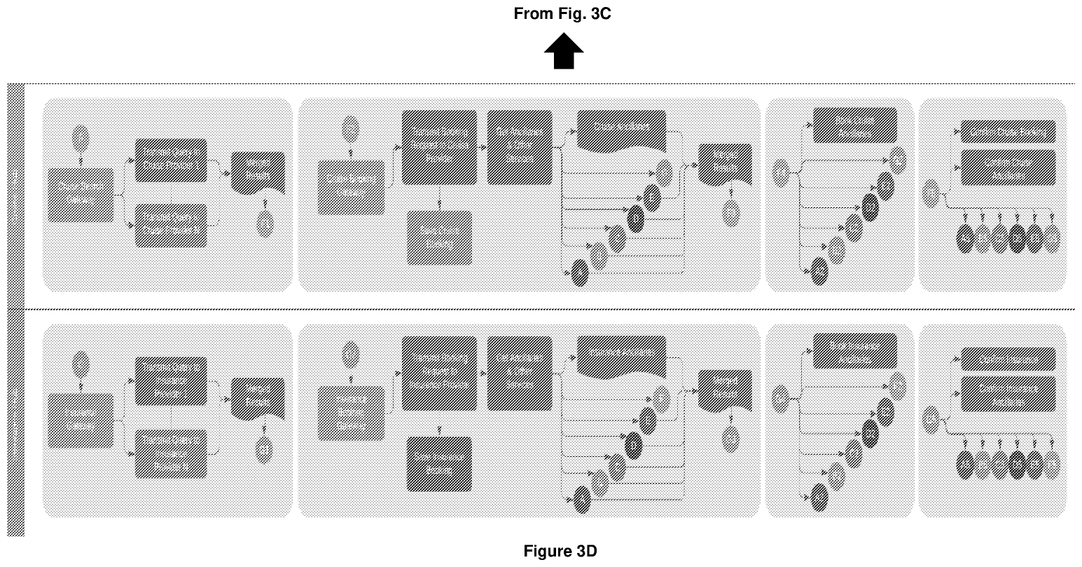

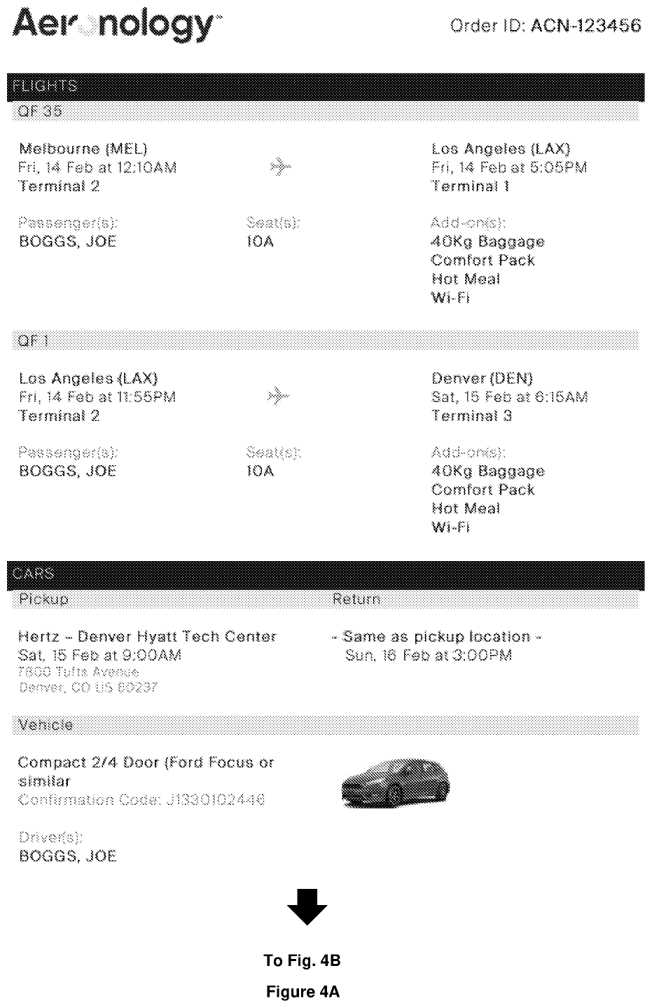

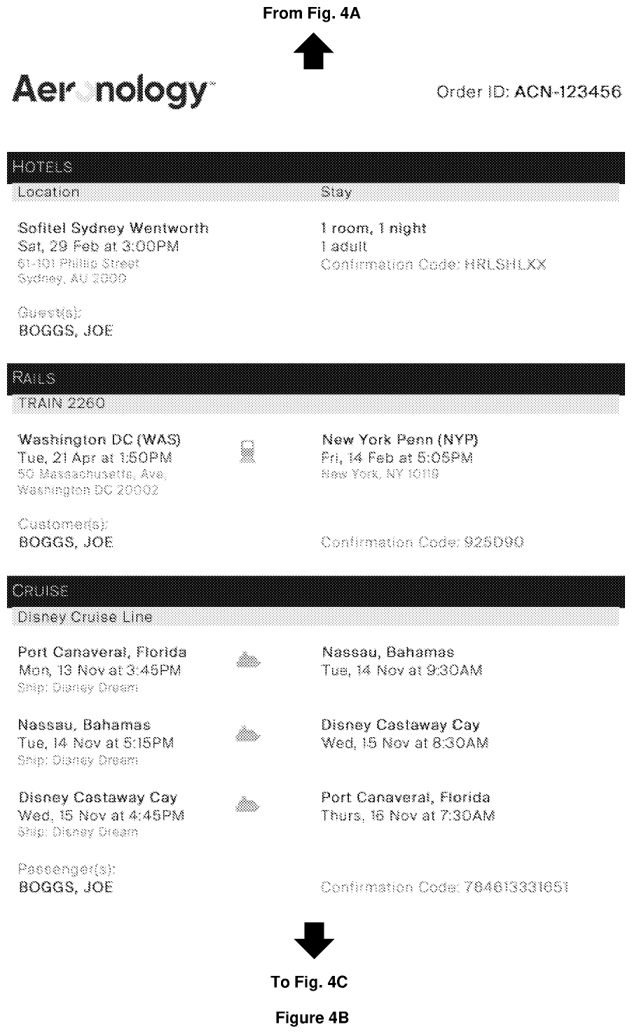

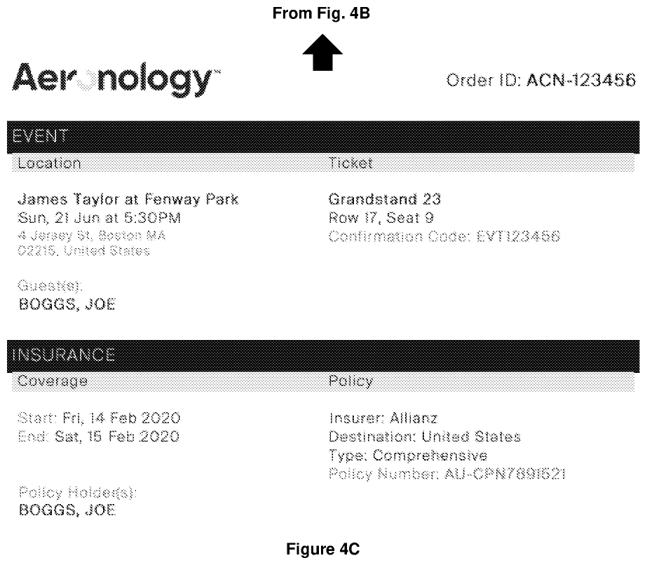

FIGS. 3A to 3D show example workflows for searching, booking, confirming, and building an example integrated multimodal travel itinerary for an example multimodal travel trip that comprises flights, cars, hotels, tours/events, rail, cruise, and insurance. Each workflow may be an independent workflow for a specific travel mode that may be integrated with other workflows for other travel modes by adding them as ancillary services. It is therefore unnecessary to start with a flight, but instead it is possible, for example, to start with a hotel search and add flights, cars, etc, as ancillaries. FIGS. 4A to 4C show an example integrated multimodal travel itinerary produced by the example workflows.

It will be appreciated that the system 100 may be further configured to provide a wide range of additional services related to multimodal travel bookings, such as shopping and booking, validations, quotes, prime ticketing, ticket changes, payment options, a commission database, mid/back office functions, collateral, refunds, cancellations, agency database, reporting, multilingual GDS error conversion, online Electronic Miscellaneous Document (EMD) book and issue, two-way messaging, etc.

Embodiments of the present invention provide a system, method and computer program that are both generally and specifically useful for aggregating and integrating multimodal travel bookings.

For the purpose of this specification, the word “comprising” means “including but not limited to,” and the word “comprises” has a corresponding meaning.

The above embodiments have been described by way of example only and modifications are possible within the scope of the claims that follow.

1. A system for integrated multimodal travel bookings, the system comprising:
an application programming interface (API) aggregation gateway configured to provide multiple API connections to multiple travel inventory systems to access, retrieve and aggregate multiformat travel inventory data for a multimodal travel trip by a traveller; and
a workflow engine configured to execute multiple workflows to:
merge the aggregated multiformat travel inventory data into multiple travel bookings;
send the multiple travel bookings to the multiple travel inventory systems;
receive multiple travel confirmations from the multiple travel inventory providers; and
merge the multiple travel confirmations into an integrated multimodal travel itinerary for the traveller.

2. The system of claim 1, wherein the multiple workflows are further configured to process multiple payments for the multiple travel bookings via multiple payment gateways.

3. The system of claim 1, wherein the multiple travel inventory systems comprise Global Distribution Systems (GDSs), Customer Reservation Systems (CRSs), New Distribution Capability (NDC) interfaces, Online Booking Tools (OBTs), Online Travel Agencies (OTAs), Low-Cost Carrier (LCC) websites, and combinations thereof.

4. The system of claim 1, wherein the multiformat travel inventory data comprises extensible markup language (XML) data, NDC Standard data, JavaScript object notation (JSON) data, Electronic Data Interchange (EDI) data, and combinations thereof.

5. The system of claim 1, wherein the multimodal travel trip comprises airlines, railways, ferries, cruises, buses, hotels, car rentals, tours, events, insurances, and combinations thereof.

6. The system of claim 1, wherein the multiple workflows may comprise XML workflows, JSON workflows, EDI workflows, and combinations thereof.

7. A computer-implemented method for integrated multimodal travel bookings, the method comprising:
providing multiple API connections to multiple travel inventory systems to access, retrieve and aggregate multiformat travel inventory data for a multimodal travel trip by a traveller;
executing multiple workflows to:
merge the aggregated multiformat travel inventory data into multiple travel bookings;
send the multiple travel bookings to the multiple travel inventory systems;
receive multiple travel confirmations from the multiple travel inventory providers; and
merge the multiple travel confirmations into an integrated multimodal travel itinerary for the traveller.

8. A non-transitory computer-readable storage medium storing a computer program configured, when executed by a processor, to perform a method comprising:
providing multiple API connections to multiple travel inventory systems to access, retrieve and aggregate multiformat travel inventory data for a multimodal travel trip by a traveller;
executing multiple workflows to:
merge the aggregated multiformat travel inventory data into multiple travel bookings;
send the multiple travel bookings to the multiple travel inventory systems;
receive multiple travel confirmations from the multiple travel inventory providers; and
merge the multiple travel confirmations into an integrated multimodal travel itinerary for the traveller.
